(19) United States
(12) Patent Application Publication
(10) Pub. No.: US 2025/0273904 A1
(43) Pub. Date: Aug. 28, 2025

(54) CONNECTOR WITH ROTATABLE LEVER AND ELASTIC LATCH FOR SECURE MATING WITH COUNTER-CONNECTOR

(71) Applicant: Aptiv Technologies AG, Schaffhausen (CH)

(72) Inventor: Norbert DOBERNIG, Lauf (DE)

(21) Appl. No.: 19/035,111

(22) Filed: Jan. 23, 2025

(30) Foreign Application Priority Data
Feb. 27, 2024 (EP) 24159820.0

(51) Int. Cl. H01R 13/629; H01R 13/627; H01R 43/26

(52) U.S. Cl. CPC H01R 13/62938; H01R 13/6271; H01R 43/26

(57) ABSTRACT

A connector designed for mating with a counter-connector through the insertion of a connector housing into a counter-connector housing includes a lever that rotates around an axis between a first position for pre-engagement and a second position for full insertion. The connector features a latch with a tongue parallel to the lever's rotation plane, elastically flexible at its connection area with the housing. The tongue's free extremity blocks lever rotation in the delivery position, thereby preventing movement toward the mated position by abutting the lever. This extremity is displaced from its blocking position by a cam-like shape on the counter-connector during pre-engagement. The blocking action is cantilevered relative to the tongue's connection with the housing and/or angled with respect to the tongue's normal direction, causing deformation within the tongue's plane. This configuration ensures secure pre-engagement and controlled transition to the fully mated position.

### CROSS-REFERENCE TO RELATED APPLICATION

This application claims the benefit of and priority to European Patent Application No. 24159820.0 filed on Feb. 27, 2024, the contents of which are incorporated by reference herein.

### TECHNICAL FIELD

The present disclosure relates to an electrical connector, of the kind with a mobile lever, which is latched in an unmated position as long as the connector is not inserted into its counter-connector.

### BACKGROUND

Connectors are used to assemble several previously made devices, usually two, in order to make an electrical connection between them that allows electrical energy and/or signals to be transmitted between these elements. These devices most often include a cable to be connected with another cable or with a motor or another type of device such as a computer or a sensor or a lighting device.

Such a connector often includes a mobile lever, which may have various functions depending on the design of the connector. A lever may be arranged so as to provide a coupling aid, where an action on the lever generate an effort that bring connector and counter connector closer to each other. A lever may also be arranged so as to lock the connector and counter connector together, by preventing them from moving off from each other. Such functionalities may also be combined together or with others.

Before mating the connector, this lever should be in an “open” position, in which the connector is ready to be mated with its counter connector. So as to ensure that the lever will not be moved out of this open position as long as the connector and counter connector are not ready to be mated together. As illustrated in FIGS. 1, 2a, and 2b, this latch is made by a deformable lug 10 extending from the connector housing 3 and protruding into a cut-out 13 of the lever 6. An extremity 23 of this lug 10 provides an abutment to a shoulder 25 of the lever 6, thus preventing the lever 6 to be rotated R9 toward its mated position. When the housing 3 of the connector 1 is inserted M9 into the counter-connector 35, as illustrated in FIG. 2b, a protruding cam 30 of the blocking lug 10 is laterally pushed inward by a protruding part 37 of the counter-connector. The blocking lug 10 is thus bent inward and its abutment surface 23 is taken out of the path of the lever shoulder 25, thus allowing the c 6 to be rotated R9.

However, it is still desirable to enhance such a connector. In particular, it appears that such blocked lever presents some drawbacks, especially if a large load is applied on the lever when blocked in open position, such as during storage, or transport, or handling such as during harness assembling operations.

Traditional connector systems often rely on simple frictional engagement or basic latch mechanisms to secure a connector to a counter-connector. These systems typically involve a straightforward insertion process where the connector is pushed into the counter-connector until a secure fit is achieved. However, such systems can be prone to accidental disconnection due to vibrations or external forces, as the frictional engagement may not provide sufficient retention force. Additionally, the lack of a guided insertion process can lead to misalignment, resulting in potential damage to the connector pins or the counter-connector housing.

### SUMMARY

One aim of the present disclosure is to overcome some or all of the disadvantages of the prior art. In particular, it is intended to provide a more robust and reliable behavior of lever-housing interface under load when in pre-use position, while optimizing design compromises such as regarding compacity, weight, or economy of material, of the connector.

These objectives are achieved partially or wholly, according to the disclosure, by a device and method having the features described below.

The present disclosure relates to a connector with a rotating mating lever, notably for electrical appliance in an electrical vehicle.

An elastic L-shaped latching tongue in a lever cutout blocks rotation when in delivery position with unlatching by bending the tongue through pre-engaging connector into counter-connector.

Lever blocking is provided by edge latch tongue, with an effort inducing deformation into an in-plane tilting rotation under excessive load from the lever.

Beyond a first determined blocking effort threshold, tilting deformation causes tongue footprint to overlap footprint of a housing cutout, thus blocking tongue inward bending. Beyond a second threshold, preferably greater than the first threshold, a housing supporting rib blocks tilting deformation.

Lever cutout forms a retention slit, with internal flange retained by a housing retaining member, and external flange retaining latch tongue from bending outward.

Thanks to these provisions, it is possible to obtain a more robust behavior of the lever-housing interface under load when in pre-use position (e.g., storage, transport, or handling such as harness assembling), and/or with a better compacity, weight and economy of material, or an optimized compromise of such constraints.

Multiple embodiments of invention are hereby envisioned, which include the optional features here disclosed, according to all of their feasible combinations.

### BRIEF DESCRIPTION OF THE DRAWINGS

FIG. 1 is a perspective view of a connector according to the prior art.

FIG. 2a is a detailed perspective view of the housing latch of the connector of FIG. 1 according to the prior art.

FIG. 2b is a detailed transverse section view of the housing latch of the connector of FIG. 1, upon pre-engagement of the latter into its counter-connector according to the prior art.

FIG. 3 is a lateral view of a connector in delivery position according to some embodiments.

FIG. 4 is a detailed view of the housing latch of the connector view of FIG. 3 according to some embodiments.

FIG. 5a and FIG. 5b are views, respectively in perspective and in detailed transverse section view (A-A from FIG. 4) of its housing latch, of the connector of FIG. 3 in delivery position according to some embodiments.

FIG. 6a and FIG. 6b are views, respectively in perspective and in detailed transverse section view (A-A) of its housing latch, of the connector of FIG. 3 upon its pre-engagement into its counter-connector according to some embodiments.

FIG. 7a and FIG. 7b are views, respectively in perspective and in detailed transverse section view (A-A) of its housing latch, of the connector of FIG. 3 after its final mating engagement into its counter-connector according to some embodiments.

FIG. 8 is a detailed perspective view of the housing latch of the connector housing of the FIG. 3, without its assistance lever according to some embodiments.

FIG. 9 is a detailed lateral view of the housing latch of the connector housing of the FIG. 3, without its assistance lever according to some embodiments.

FIG. 10a and FIG. 10b are detailed perspective views of a flange area of the assistance lever of the connector of FIG. 3, respectively from its internal side and from its external side according to some embodiments.

FIG. 11 is a detailed top section view (B-B in FIG. 9) of the housing latch area of the connector of FIG. 3, with its assistance lever in delivery position according to some embodiments.

FIG. 12 is a detailed lateral view of the housing latch of the connector of the FIG. 3, shown without its assistance lever for illustrating its in-plane tilting deformation when under load from the lever in delivery position according to some embodiments.

FIG. 13 is a detailed perspective view of the housing latch of the connector of the FIG. 3, shown without its assistance lever for illustrating its tilting and inward bending deformation when under load from the lever in delivery position according to some embodiments.

In the various figures, similar or identical elements have the same references.

### DETAILED DESCRIPTION

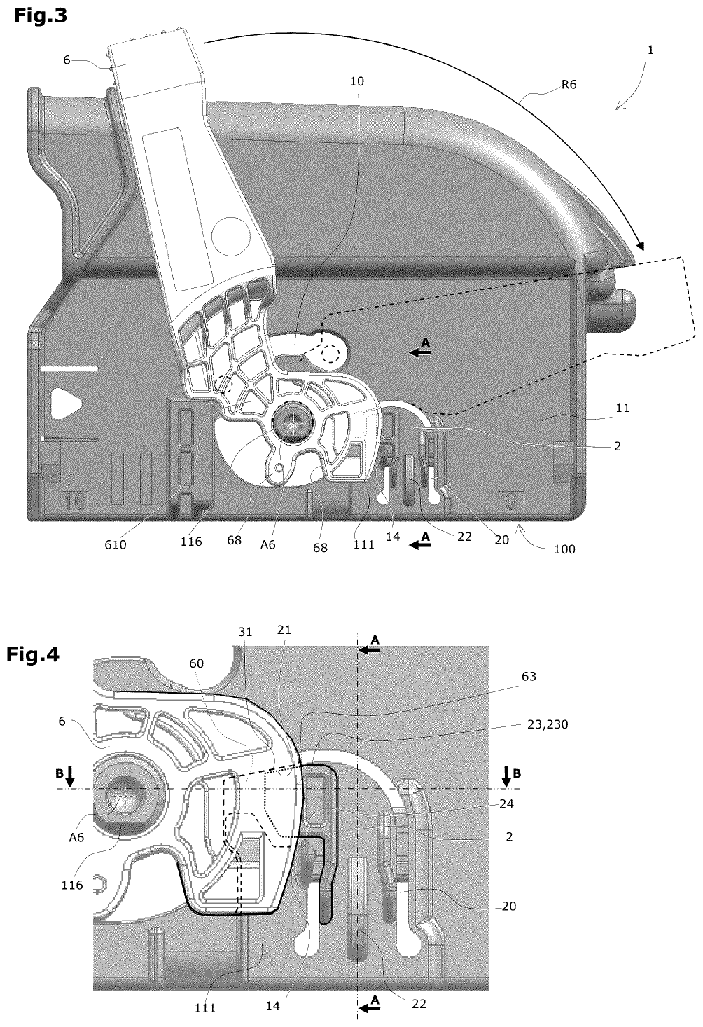

FIGS. 3 to 5b illustrate a connector according to an exemplary embodiment of the present disclosure, when in delivery position.

Connector 1 has a housing 11 arranged for receiving, within an opening 100 at the bottom of the drawing, a connection module that bears the electrical terminals (not shown) fixed at the extremity of a cable (not shown), for example female terminals.

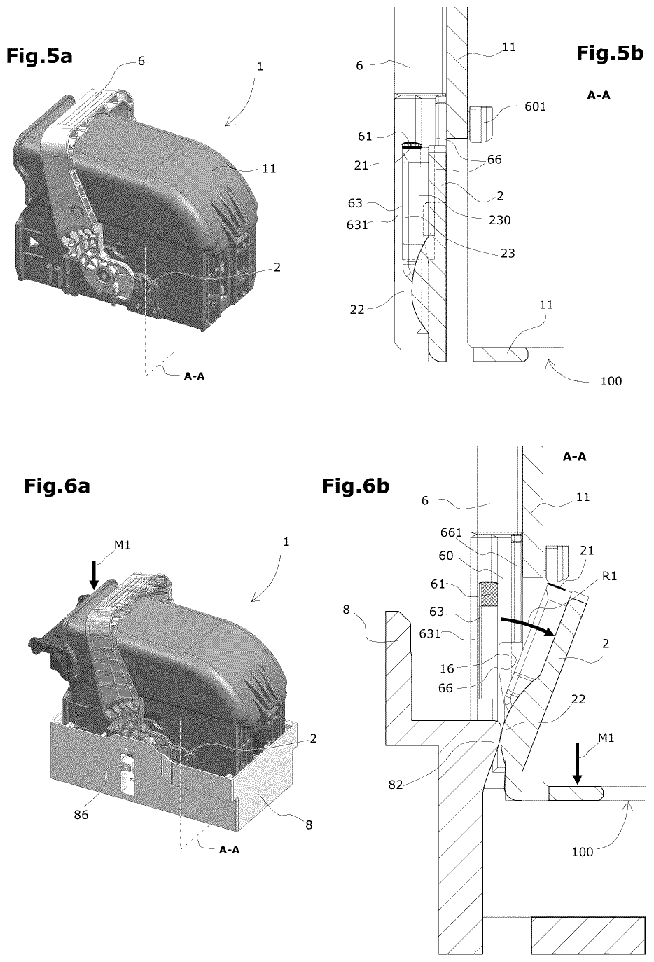

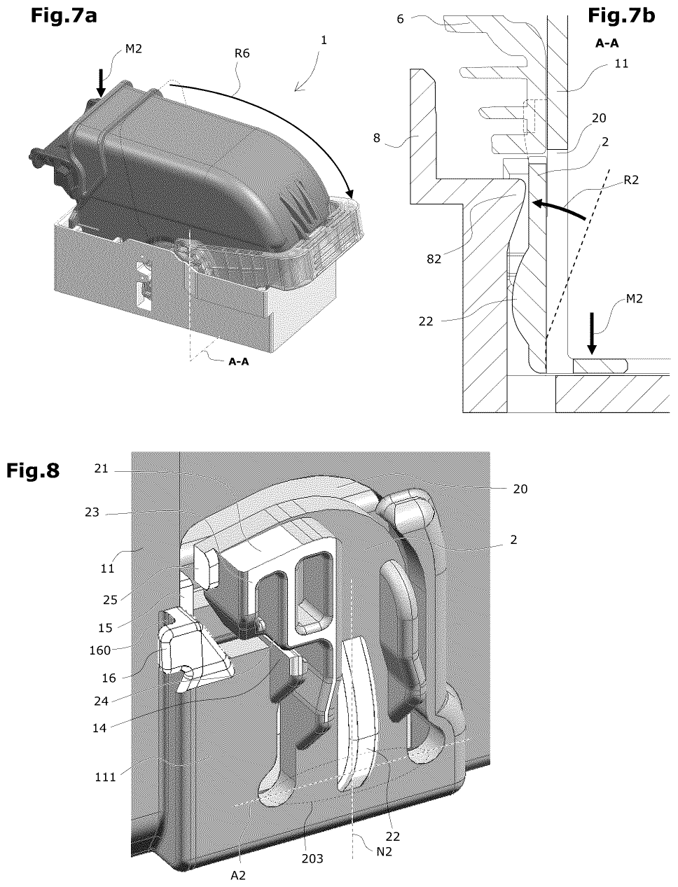

The assistance lever 6 is rotatably mobile between a delivery or “open” position (shown in FIG. 3 and FIG. 5a) and a mated position (shown in FIG. 7a), around a transverse axis A6. Mating operation includes a first operation of “pre-engagement”, in which the connector is inserted into the counter-connector housing 8 in a first translational movement M1, as illustrated in FIG. 6a. Once in its pre-engagement position, the assistance lever 6 is then rotated R6, as illustrated in FIG. 7a, toward its mated or “closed” position.

Interactions of the assistance lever 6, the connector housing 11 and the counter connector housing 8, in the housing latch area, will here be described only for one of the lateral sides, here on the right side if the lever rotation R6 is called a forward movement. However, while not being a necessary feature, the same shapes and functionalities symmetrically exist on the “left” side.

As illustrated in FIG. 3 and FIG. 4, this lever 6 has radial teeth 68 that are arranged for, during this lever rotation R6, engaging with corresponding lateral teeth or protrusion(s) 86 of the counter-connector housing 8 (non-visible) so as to forcibly bring both housings 11 and 8 closer form one each other, in a second translational movement M2 as illustrated in FIG. 7a, thus performing a kind of assistance to mating movement.

Typically, the connector 1 is stored in its delivery position, alone or already assembled with its cable, i.e., ready to be mated, and is delivered in this same configuration to the facility that will mate it with a corresponding counter-connector 8. During these prior operations, so as to avoid this lever 6 to be involuntarily moved out of this delivery position, the latter is blocked in the delivery position by a latch 2 of the connector housing 11.

As illustrated in FIGS. 5a, 8, 9, 11, this housing latch 2 includes a L-shaped tongue that is linked at its bottom with the wall of the lateral connector housing and is separated from it by a peripheral cut-out 20, in a housing wall 111 that protrudes from the main wall by a small offset (typically by the thickness of the tongue 2).

As illustrated in FIG. 10a and FIG. 10b, the lever 6 has an opening or cut-out called “retention slit” 60 with a radial surface 61 that comes in flat abutment with a corresponding top surface 21 of the housing latch 2, so as to prevent a rotation R6 of the lever 6 when in delivery position. This abutment cooperation 61, 21 is illustrated in FIGS. 4, 5b, and 9.

As illustrated in FIG. 6b, when the connector 1 is pre-engaged by first insertion M1 in the counter-connector 8, a fixed internal cam-like protrusion 82 of its housing 8 pushes on a rounded convex release rib 22 of the housing latch 2. This cam interaction bends R1 the latch tongue 2 inward of the connector housing 11, thus retracting its contact surface 21 out of the path of the lever retention slit 60 and thus release its blocking 21-61, thereby allowing the lever 6 to be rotated R6 toward its mated position.

An operator then rotates R6 the lever 6, thus completing M2 the mating of connector 1 and counter-connector 8 together, including the mating of their respective terminals and counter-terminals together. Final mated position is illustrated in FIG. 7b, which shows that the housing latch 2 tongue elastically comes back into its initial position as it went pass the contact of the cam-like protrusion 82 of the counter-connector housing 8.

Authors of the present disclosure found that, when the connector 1 is in delivery position with the lever 6 blocked by the latch 2, it may happen that an important effort be applied on the lever 6 that could provoke a deformation of the latch 2 and/or the articulation part 610 that are articulated on the connector housing 11. This may result in freeing the lever 6 from its blocking and/or its articulation A6, thus rending the whole connector damaged or unsuitable for its intended use and requiring it to be either re-assembled or replaced.

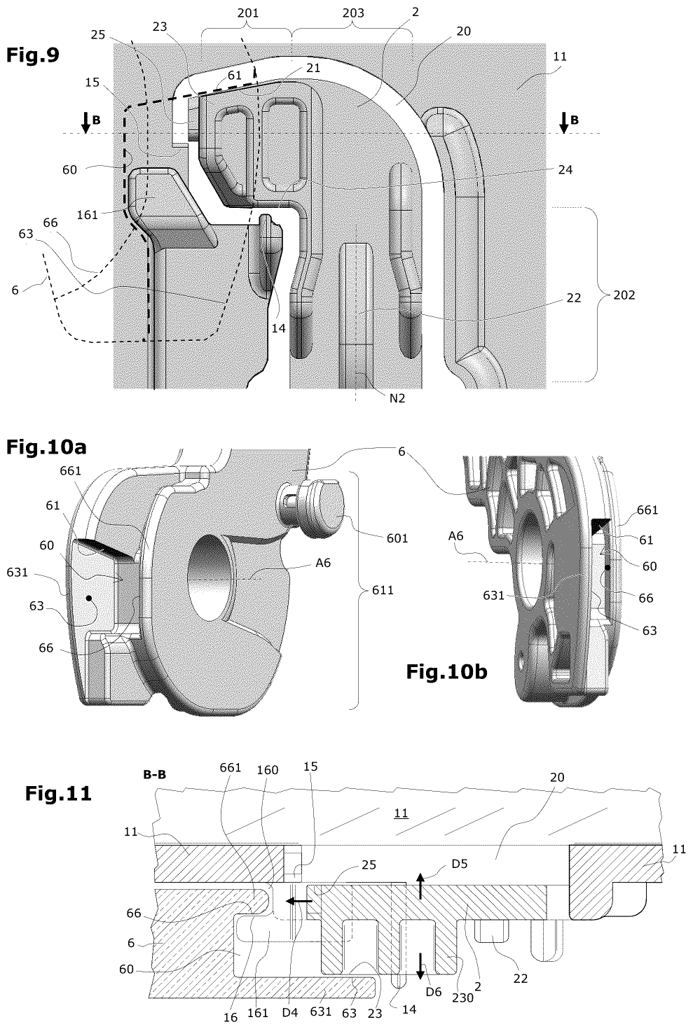

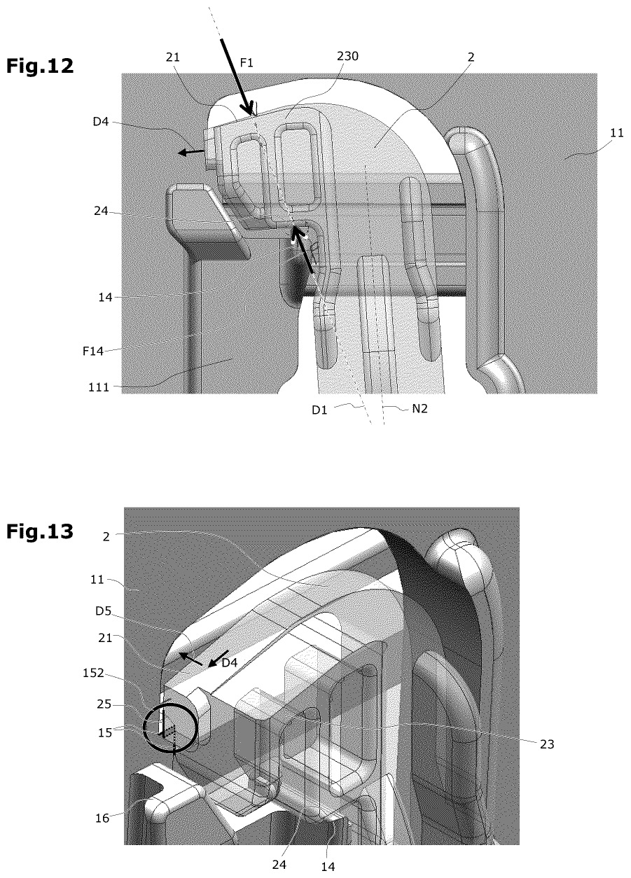

As can be seen in the drawings, e.g., FIG. 9, the housing latch 2 has a shape of a “L”, where the blocking face 21 is borne on the angled part 201 of the free extremity of the tongue, so that the direction D1 of the effort F1 applied by the lever blocking face 61 is cantilevered relating to the tongue part 202 directly extending from its housing connection. As a preferred feature, the direction D1 comes out of the footprint of the angled part 201 before it reaches the tongue-housing connection 203, as illustrated in FIG. 12; while the direction is also angled with the normal N2, which is the main resistance direction as being perpendicular to the bending axis A2 of the tongue-housing connection 203.

As illustrated in FIG. 12, when the lever effort F1 increases, the latch tongue 2 tends to deform at least in a “tilting” direction D4 that is substantially in-plane with the tongue.

As illustrated in FIG. 9 and FIG. 12, the housing wall 111 bears a reinforced part, here a transverse supporting rib 14, that is situated under the angled part 201 of the tongue 2, so as to come in contact abutment with a bottom face of the angled part 201, or supporting face 24, and thus stop or limit such tilting movement D4 by a supporting effort F14. Preferably, this supporting face 24 is substantially aligned with the effort direction D1 of the lever blocking effort F1.

When the lever effort F1 increases, the latch tongue 2 may also tend to deform in an inward bending direction D5, that may displace its extremity into the plane of the housing wall 111 and thus retract the latch blocking face 21 enough freeing the lever 6 from its delivery blocking.

As illustrated in FIG. 9 and FIG. 12, the free extremity of the angled part 201 of the latch tongue 2 bears a shoulder, or latch retention rib 25, that is out of the footprint of the housing wall 111 around the tongue cut-out 20 when the latch 2 is in its initial unloaded position so as to allow a pure inward bending R1 during the pre-engagement movement M1. However, the external edge of the cut-out 20 has a shoulder, or housing retention rib 15, the footprint of which is situated near enough of the latch retention rib 25 for them to intersect each other when the latch tongue 2 is tilted in the in-plane direction D4 under an effort F1 of the blocked lever, as illustrated in FIG. 12. Such footprint intersection 152 thus provide an abutment between the latch retention rib 25 and the housing retention rib 15 that prevent the latch tongue 2 to retract into the cut-out 20 under excessive load F1 of the lever, while not preventing the latch tongue 2 from retracting R1 when pre-engaging M1 (if without excessive load on the lever) the connector as in FIG. 7a.

It can be understood that these provisions enable a significantly high part of the blocking effort F1 to be supported by the housing 11 instead of the latch tongue connection 203. Thus, the lever can support a significantly higher (involuntary) load without provoking an unwanted retracted failure of the housing latch 2 or damage to its connection 203.

As illustrated in FIG. 10a and FIG. 10b, the cut-out of the retention slit 60 is an opening that opens toward the peripheral surface of the articulation part 610 of the lever 6 branch, so as to receive the angled part 201 of the housing latch 2 and its blocking face 21. Along the lever rotation axis A6, this retention slit 6 is surrounded by two closed flat surfaces, here called internal flange 611 and external flange 631, that radially extend beyond the bottom of the retention slit 60.

This external flange 631 has a flat surface transverse to the rotation axis A6, called external retention face 63, facing the external face 23 of the housing latch 2.

The housing latch 2 bears a protruding part 230, preferably the same thickness as its blocking face 21. The flat external face 23 of this protruding part 230 comes in a form-fit abutment contact with the external retention face 63 of the lever, thus preventing the latch tongue 2 from being bent outward D6.

The connector housing 11 bears a lateral protrusion that bears a retention member (or rib) 161. The retention member extends transversely toward the rotation axis A6 and defines with the housing wall 111 a retention slit 60. The internal flange 661 of the lever articulation part 610 is inserted within the housing retention slit 160.

The internal flange 661 has a flat surface transverse to the rotation axis A6, called internal retention face 66, that comes in a form-fit abutment contact with faces the inward face 16 of the housing retention member 161, thus keeping the internal retention face 66 to move away from the housing wall 111.

Articulations 611 of the lever 6 are thus prevented from spreading away from the connector housing and from leaving the pivot 116 of it, which would result in requiring a supplemental operation of re-assembling the connector. This comes in complement of the similar feature provided by the lever nipples 601 that are retained by the housing guiding groove 10.

As the lever articulations 611 are retained from moving away from the housing, they themselves prevent the housing latch(es) 2 form bending outward under lever effort F1, through their respective abutting faces 23 and 63, which could result in an unwanted releasing of their blocking surfaces 21 and 61.

Thanks to such provisions and their combinations, the housing latch 2 is less prone to be deformed in all main potential directions D4, D5, D6, and to have its most fragile part 203 damaged. An improved reliability is thus provided when the connector 1 is under excessive effort F1 of its lever 6.

While this invention has been described in terms of the preferred embodiments thereof, it is not intended to be so limited, but rather only to the extent assembly forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no feature limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

The term “and/or” is only an association relationship describing associated objects and represents that three relationships may exist. For example, A and/or B may represent three conditions: i.e., independent existence of A, existence of both A and B and independent existence of B. In addition, the character “/” in the disclosure usually represents that previous and next associated objects have an “or” relationship.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

### LIST OF REFERENCE NUMBERS

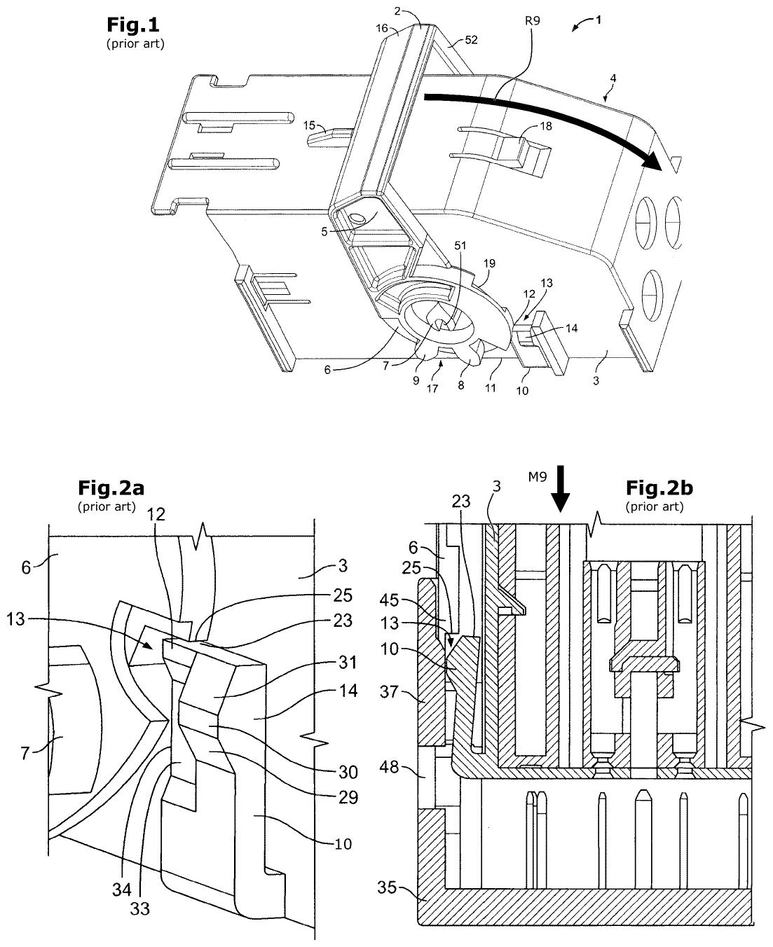

FIG. 1, FIG. 2a, and FIG. 2b (Prior art)
1 connector
10 latch of connector housing
13 cut-out of the lever
25 shoulder of the lever
3 connector housing
30 protruding cam of the latch
35 counter-connector
37 protruding part of the counter-connector
6 lever
M9 connector mating movement
R9 lever mating rotation

### FIGS. 3 to 13

10 circular groove of connector housing for guiding lever nipple
100 bottom opening of the connector housing, for receiving a connection module
11 connector housing
111 protruding area of connector housing wall, bearing the housing latch
116 pivot of the connector housing
14 supporting rib of housing, for preventing in-plane tilting or housing latch
15 retention rib or shoulder of housing, for preventing inward bending of latch, subsequent to latch tilting
152 overlapping-intersection area between latch retention rib and housing retention rib
16 retention face of housing retention slit, for spreading of lever
160 retention slit of connector housing, for receiving lever internal flange
161 retention member or rib of connector housing, defining its retention slit
2 housing latch for blocking lever in delivery position
20 housing cutout, surrounding the latch tongue footprint
201 angled part at the free extremity of the housing latch L-shaped tongue
202 direct extension part of the L-shaped latch tongue
203 connection between the housing latch tongue and the part of the connector housing it is cut out from
21 blocking face of housing latch, for blocking lever in delivery position
22 release rib, for bending and retracting latch upon connector pre-engagement in its counter-connector
23 latch external contact face, for preventing outward bending of housing latch
230 retention part of housing latch, bearing the external contact face
24 supporting face of housing latch, for resting on housing supporting rib upon latch in plane tilting
25 retention rib of latch, for resting on housing retention rib and thus preventing inward bending of latch tip
6 lever for mating assistance
60 lever cutout with blocking face, retention slit for lateral retention
601 retention nipple of assistance lever
61 blocking face of lever, for blocking lever in delivery position
610 articulation part of the lever, receiving the housing pivots, at the extremities of its two branches
63 external retention face of lever external flange, for form-fit resting on latch external contact face
631 external flange of lever articulation part
66 internal retention face of lever internal flange, for form-fit resting within housing retention slit
661 internal flange of lever articulation part
68 teeth of lever for mating assistance
8 counter-connector housing
82 protruding cam of counter-connector housing, for pushing on housing latch release rib
86 teeth of counter-connector housing
A2 bending/rotation axis of the housing latch tongue
A6 rotation axis of the lever
D1 blocking direction, direction of the reaction effort from the blocking face of the housing latch against the lever effort
D4 tilting direction of housing latch, when receiving too much load from lever
D5 inward potential bending direction of housing latch, when receiving too much load from lever
D6 outward potential bending direction of housing latch, when receiving too much load from lever
F1 blocking effort of the lever blocking face on the latch blocking face
F14 supporting effort of the housing supporting rib on the bottom of the latch angled part
M1 pre-engagement insertion movement of connector into its counter-connector
M2 final mating insertion movement of connector into its counter-connector
N2 normal direction of the housing latch tongue
R1 retracting movement of housing latch, when pushed by counter cam effect upon pre-engagement insertion
R2 return movement oh housing latch, upon final mating of connector
R6 lever rotation movement, for final mating of connector

1. A connector configured to be mated with a counter-connector, comprising:
a connector housing;
a lever rotatably mobile in relation to the connector housing around a rotation axis between at least a first position in which the connector housing is able to be pre-engaged into the counter-connector housing through a first insertion movement and a second position in which the connector housing is able to be fully inserted into the counter-connector housing until a fully mated position; and
a latch comprising a tongue that is substantially parallel to a rotation plane of the lever and is elastically flexible through a bending of a connection area between the tongue and the housing, the tongue having a free extremity which is situated in a blocking position when the connector is in delivery position where it provides a blocking action that prevents the lever to be rotated out of its delivery position and toward its mated position by abutment with the lever, the free extremity being arranged to be pushed out of its blocking position by a cam-like shape of the counter-connector when the connector is pre-engaged into the counter-connector, wherein the blocking action opposes the lever along a blocking direction blocking direction that is cantilevered in relation to the connection of the latch tongue with the housing and/or angled with a normal direction of the latch tongue which is oriented for causing the latch tongue to deform at least within the plane of the latch tongue.

2. The connector according to claim 1, wherein the connector housing comprises a supporting face which is situated so as to block a tilting movement of the latch characterized by a movement component within a plane parallel to the latch and/or its connection, by abutment against a supporting face of the latch tongue that faces a housing supporting rib situated on an edge of the latch tongue.

3. The connector according to claim 2, wherein the housing latch comprises an L-shape with a first part, forming one part of the L-shape, that directly extends from the connection between the housing latch tongue and the connector housing, perpendicularly to the bending axis of the connection, and a second part, angled from the first part so as to form another part of the L-shape, that includes a free extremity of the housing latch tongue, the angled part bearing the blocking face of the housing latch on a first lateral edge and bearing the supporting face of the housing latch on a second lateral edge opposite to the first lateral edge.

4. The connector according to claim 2, wherein the connector housing comprises a retention rib situated and arranged so as to allow the free extremity of the latch tongue to retract out of its blocking position when it is pushed by the cam-like shape of the counter-connector housing while being not deformed through a tilting movement over a determined threshold, and to prevent the free extremity from retracting out of its blocking position when the latch tongue is deformed through a tilting movement over a determined threshold, such as under a load from a lever blocking face, the retention rib thus preventing an unwanted freeing of the lever when under excessive load in delivery position.

5. The connector according to claim 4, wherein the connector housing comprises a cutout which at least partially surrounds the latch tongue according to the direction of the retracting movement of the tongue and wherein the edge of the cutout is arranged to overlap the latch tongue in an intersection area when the latch tongue is deformed through a tilting movement over a determined threshold, the intersection area thus producing an abutment between the edge of the housing cutout and the edge of the latch tongue, thus realizing the housing retention rib and respectively the latch retention rib.

6. The connector according to claim 1, wherein the lever comprises a branch that comprises an articulation part at a free extremity which is pivotally articulated around the lever rotation axis, wherein the articulation part comprises a cutout that is radial to its rotation axis and an opening on its periphery, the cutout defining in a plane parallel to its rotation axis a lever blocking face that comes in abutment by complementary contact with a housing latch blocking face borne on an edge of the housing latch and wherein the lever cutout is closed, on its side facing the connector housing, by a flange called internal flange, the cutout thus forming a retention slit, and the connector housing comprises a retention member protruding radially toward the lever rotation axis, that protrudes within the retention slit when in delivery position, and that bears a retention face able to come in form-fit contact with a retention face of the internal flange, the retention member thus providing an abutment that prevents the lever articulation part to be bent toward the connector housing in an inward direction, and thus the lever blocking face to be taken out of abutment on the latch blocking face, when the lever is in delivery position.

7. The connector according to claim 1, wherein the lever comprises a branch that comprises an articulation part at a free extremity which is pivotally articulated around the lever rotation axis, wherein the articulation part comprises a cutout that is radial to its rotation axis and opening on its periphery, the cutout defining in a plane parallel to its rotation axis a lever blocking face that comes in abutment by complementary contact with a housing latch blocking face borne on an edge of the housing latch and wherein the lever cutout is closed, on its side opposite to the connector housing, by a flange called external flange, the cutout thus forming a retention slit, and the housing latch comprises a retention part facing oppositely to the connector housing, that is inserted within the lever retention slit when in delivery position and bears an external contact face able to come in form-fit contact with a retention face of the external flange, the external flange thus providing an abutment that prevents the latch tongue to be bent away from the connector housing in an outward direction, and thus the lever blocking face to be taken out of abutment on the latch blocking face, when the lever is delivery position.

8. The connector according to claim 1, wherein the housing latch tongue defines a release rib perpendicular to the pre-engagement insertion movement and/or to a final mating insertion movement on its face opposite to the connector housing and wherein the release rib protrudes in a continuously variable convex shape on its part pushed by the cam-like shape of the counter-connector housing during the pre-engagement insertion movement, and has a shape arranged for being freed during the final mating insertion movement.

9. The connector according to claim 8, wherein the release rib protrudes in a continuously variable convex shape on its part pushed by the cam-like shape of the counter-connector housing during a movement of extracting the connector housing from its counter-connector housing.

10. A method for connecting a wire harness with a counter-connector, comprising:
providing a connector having a lever rotatably mobile in relation to a connector housing around a rotation axis between at least a first position in which the connector housing is able to be pre-engaged into the counter-connector housing through a first insertion movement and a second position in which the connector housing is able to be fully inserted into the counter-connector housing until a fully mated position and a latch comprising a tongue that is substantially parallel to a rotation plane of the lever and is elastically flexible through a bending of a connection area between the tongue and the housing, the tongue having a free extremity which is situated in a blocking position when the connector is in delivery position where it provides a blocking action that prevents the lever to be rotated out of its delivery position and toward its mated position by abutment with the lever, the free extremity being arranged to be pushed out of its blocking position by a cam-like shape of the counter-connector when the connector is pre-engaged into the counter-connector, wherein the blocking action opposes the lever along a blocking direction blocking direction that is cantilevered in relation to the connection of the latch tongue with the housing and/or angled with a normal direction of the latch tongue which is oriented for causing the latch tongue to deform at least within the plane of the latch tongue; and
inserting the housing of the connector into a housing of a corresponding counter-connector, in a first pre-engagement translational movement, thus retracting the latch tongue of the connector housing.
